(19) United States
(12) Patent Application Publication
(10) Pub. No.: US 2008/0230636 A1
(43) Pub. Date: Sep. 25, 2008

(54) Condiment Dispenser

(76) Inventor: Ronald L. Post, Seattle, WA (US)

Correspondence Address: LAW OFFICE OF POLLY L. OLIVER, 3134 Parkside Circle NE, Tacoma, WA, 98422, US

(21) Appl. No.: 12/052,723

(22) Filed: Mar. 20, 2008

Related U.S. Application Data
(60) Provisional application No. 60/895,982, filed on Mar. 20, 2007.

(51) Int. Cl. A01C 15/02

(52) U.S. Cl. 239/652; 239/377; 239/502

(57) ABSTRACT

The Condiment Sprinkler is a spoon- or spatula-shaped device which provides a way for dry salt-type condiments to be evenly and effectively sprinkled onto food (in contrast to the “shaker” method). The Condiment Sprinkler comprises a generally convex bowl or open-ended shovel-shaped spoon and a handle, the shallow bowl (which may be round, ovate, or elongated) being somewhat flattened on the bottom and having raised ribs therein. The raised ribs may form a cross design. The raised ribs—whether they be in a cross design or some other appropriate design, such as ribs or bumps—serve to interfere with or dampen the centripetal and/or centrifugal forces generated when the sprinkler is waved, thereby impeding dumping or clumping of the salt-type condiment on the food. With use of the Condiment Sprinkler, the user can gain precise control over the salt-type material he/she is applying. The Condiment Sprinkler is usually of one-piece food-grade plastic construction, but may be made from any other appropriate manufacturing method or material.

In alternate embodiments, the Condiment Sprinkler may have relatively small vents or holes in the bowl or other side Walls to promote denser coverage of the condiment and/or coverage over a larger area. A user grips the handle and then fills the bowl of the Condiment Sprinkler with the dry salt-type condiment (typically by dipping). The user then uses a circular wrist motion to sprinkle the condiment over the desired food area.

### RELATED APPLICATIONS

This application is related to and claims priority under 35 U.S.C. 119(e) to U.S. provisional application Ser. No. 60/895,982, entitled “Sprinkle Spreader for Salt-type Condiment,” filed on Mar. 20, 2007, with inventor Ronald L. Post of Seattle, Wash., which is hereby incorporated by reference in its entirety.

### FIELD OF THE INVENTION

This invention pertains generally to kitchen utensils and more particularly to a unique distributing device used with granular condiments or spices that works by hindering the centripetal and/or centrifugal forces generated by waving the device in order to distribute the condiment evenly throughout the distribution area.

### BACKGROUND OF THE FIELD

Often, salt-type condiments are sprinkled over foods using one's fingers or a traditional spoon. The first mentioned—using one's fingers—requires the ineffective “pinch and sprinkle” motion which can be difficult for some users to achieve. Both methods may result in lumping, clumping, or otherwise uneven application of the condiment.

There have been attempts in the past to address these concerns. Particularly, U.S. Pat. No. 4,466,560 to Boram discloses a device that works by hindering the gravitational forces generated by tilting a scoop of particulate matter. The scoop is vibrated by an electro-mechanical means in order to overcome the forces of friction so that the particles may move freely down the scoops. Although the device hinders gravitational forces by putting up a physical barrier, the forces involved are gravitational, not centrifugal or centripetal, and the structural design is quite different, i.e., long and V-shaped instead of rounded and bowled.

U.S. Pat. No. 2,420,505 to Stith discloses a device with physical barriers dividing a spoon-like bowl. However, once again Stith's device is designed to use the force of gravity only. Stith's device—intended for dentists and the like—is used for measuring and dispensing a predetermined amount of medication through holes in the bottom of the spoon.

U.S. Pat. No. 2,187,245 to Nerney discloses a device that is intended to be a condiment sprinkler. Nerney's device combines a scoop with a sprinkler—like a salt shaker. The user scoops up product, and then inverts the device to sprinkle product through holes in the device. There are no walls—just one big interior compartment.

### SUMMARY OF THE INVENTION

The present invention solves the above-mentioned problems by providing a way for salt-type, sugar-type, or other granular condiments to be evenly and effectively applied to food or the like using a unique dispensing instrument. The condiment dispenser delivers granular condiments neatly and evenly over a given area, while allowing that the user need never touch the condiment with his/her hands and while eschewing the traditional “shaker” format. In one embodiment, the condiment dispenser may comprise a mini-spoon device having a compartmentalized convex spoon-type shallow bowl at one end of the handle. At the other end of the handle, there may be a convex honeycomb design for dipping and spreading honey or other sauces or dressings.

### BRIEF DESCRIPTION OF THE DRAWINGS

The objects, features, and advantages of the present invention will be apparent to one skilled in the art from reading the following description in which:

FIG. 1 is a perspective view of a preferred embodiment of the condiment dispenser;

FIG. 2 is a top view of the preferred embodiment showing the cross design of the raised ribs;

FIGS. 2A, 2B, 2C, 2D, 2E, and 2F show alternate designs for the raised ribs;

FIG. 3 is a bottom view of the preferred embodiment showing the honeycomb design on the back of the flared handle;

FIG. 4 is a sectional side view of the preferred embodiment shown;

FIG. 5 is a top view of an alternate embodiment of the condiment dispenser;

FIG. 6 is a side view of the first alternate embodiment;

FIG. 7 is a sectional view of the cooperative gate inside the handle showing the gate in the fully open position;

FIG. 8 shows the gate in a partially closed position;

FIG. 9 is a top view of a second alternate embodiment of the condiment dispenser;

FIG. 10 is a side view of the second alternate embodiment; and

FIG. 11 is a detail view of an alternate flared second end of the container.

### DETAILED DESCRIPTION

The following specification describes a condiment dispenser. In the description, specific materials and configurations are set forth in order to provide a more complete understanding of the present invention. But it is understood by those skilled in the art that the present invention can be practiced without those specific details. In some instances, well-known elements are not described precisely so as not to obscure the invention.

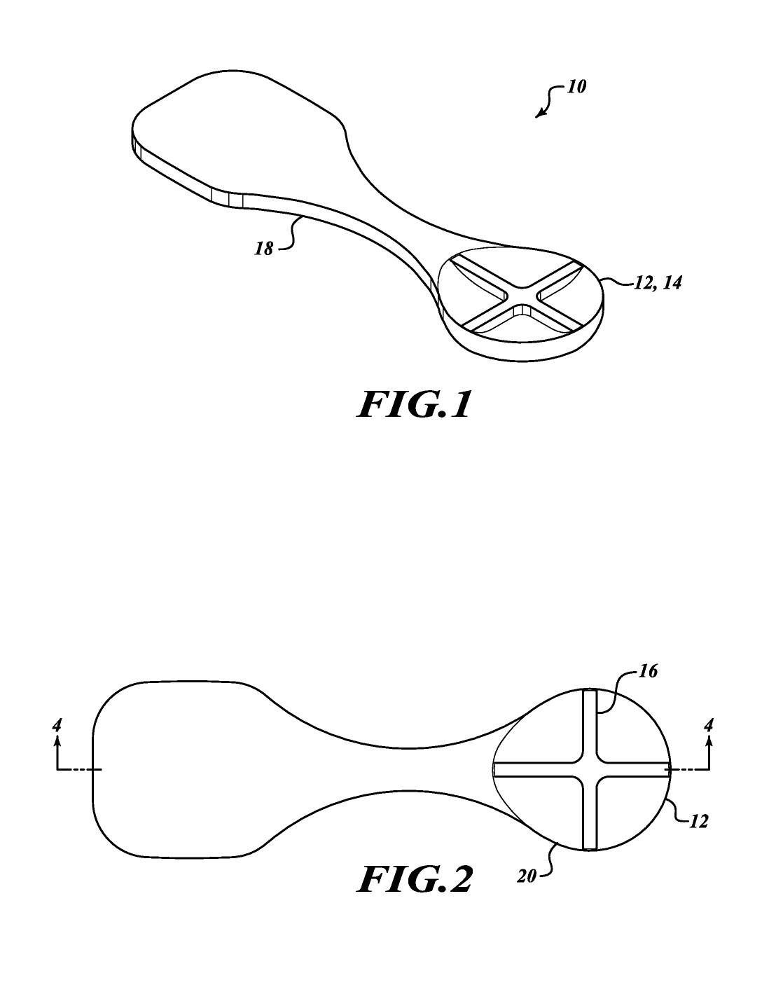

FIG. 1 shows an embodiment of the condiment dispenser 10 with a generally shallow bowl 12 as the container 14 and short handle 18. It is understood that the container 14 may take other shapes—such as a V-shaped scoop, a rectangular scoop with flat or convex bottom, an elongated oval bowl with rounded bottom, etc. A small, shallow bowl 12 has been chosen for this embodiment because it fits into many existing condiment jars and fills easily by scooping. A different shape or larger container 14 may be better applicable to alternate circumstances, such as industrial kitchen or restaurant use or for grilling. Also, it is to be noted that for this embodiment, the container 14 is open, meaning it has no top. A closed container (e.g., with a fixed or hinged lid) can be used to practice the invention; however, a closed container will probably have to define additional exit holes, slots, openings or some other way for the condiment to exit the container. In the embodiment shown, the condiment is able to exit the container over the sides of the bowl due to centrifugal and centripetal forces generated upon the User waving the device. It is intended for the user to wave the condiment dispenser in a generally circular pattern or in a generally side-to-side pattern, thereby covering a generally circular distribution area—such as a plate of food.

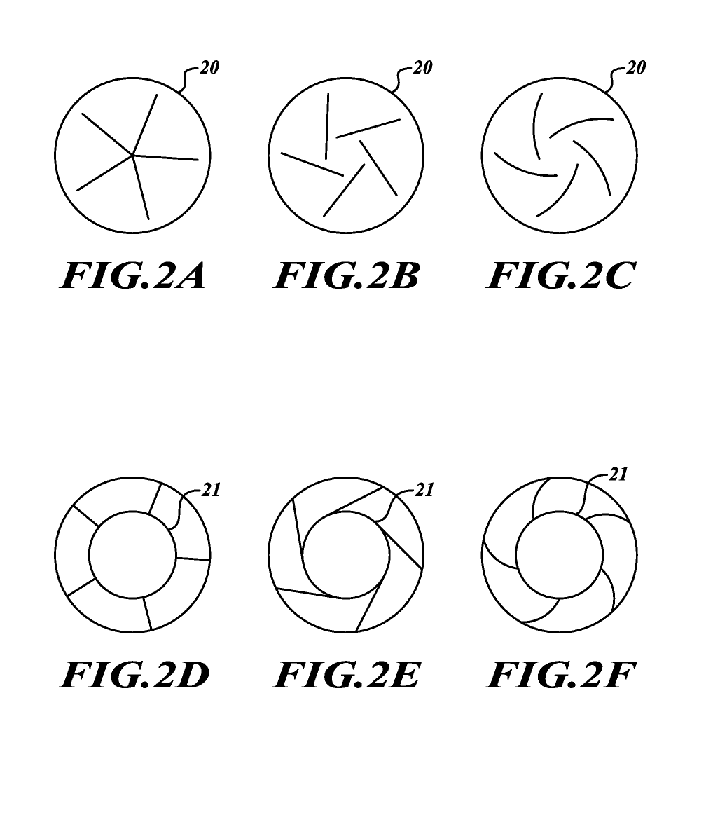

As can be seen in FIG. 2, the bowl 12 has one or more raised ribs 16, which in this embodiment form a cross design (but it is not necessary that the ribs intersect at all; they could be a plurality of separate and non-intersecting ribs). The ribs 16 are intended to hinder the centripetal and centrifugal forces generated by waving the device over the desired distribution area—typically in a generally circular or side-to-side pattern. The ribs could easily be configured in a different pattern rather than a cross, e.g., they could be placed in parallel, curved in any design, or placed so as to compartmentalize the container 14 in some other way. (See FIGS. 2A, 2B, and 2C for other rib design ideas. The angled ribs could be angled in opposite directions for right handed and for left-handed users.) For larger-sized dispensers, there could be an inner bowl 21 (shown in FIGS. 2D, 2E, and 2F) to further contain the loose granular condiment and further control its exit and distribution.

The side view of FIG. 4 shows how the raised ribs 16 are designed to be flush with the outer perimeter edge 20 of the bowl 12. This flushness allows that the container 14 once filled can be leveled off so as to measure the condiment within. If precise measurement is not a goal, then there is no need for the ribs to be flush. However, the size of the shown embodiment has been chosen to deliver a usual “right amount” of granular, salt-type condiment on a desired area (a typical dinner plate). To effectively use this utensil, the user first selects his or her condiment of choice—typically from the group of salt-type or sugar-type granular condiments. Next, the user grips the condiment dispenser by the handle (in this case typically pinching the flared end of the handle between thumb and forefinger). The user can now fill the container with the chosen condiment by dipping the container into the condiment jar and filling the bowl, or by any other convenient method (such as attaching the jar or other condiment source to the handle as in the alternate embodiment). With a bowl full of condiment, the user now distributes the condiment by waving said dispenser—typically in a generally circular or side-to-side pattern—over a chosen distribution area so that the condiment is distributed thereon. In waving, centripetal and centrifugal forces are generated which act on the grains of the condiment, urging the grains to fly out of the bowl. The raised ribs prevent such uncontrolled exit by the condiment grains and control the distribution—making it more even across the desired distribution area. The result is that the user achieves a more evenly distributed condiment covering the desired area with no clumping or lumping.

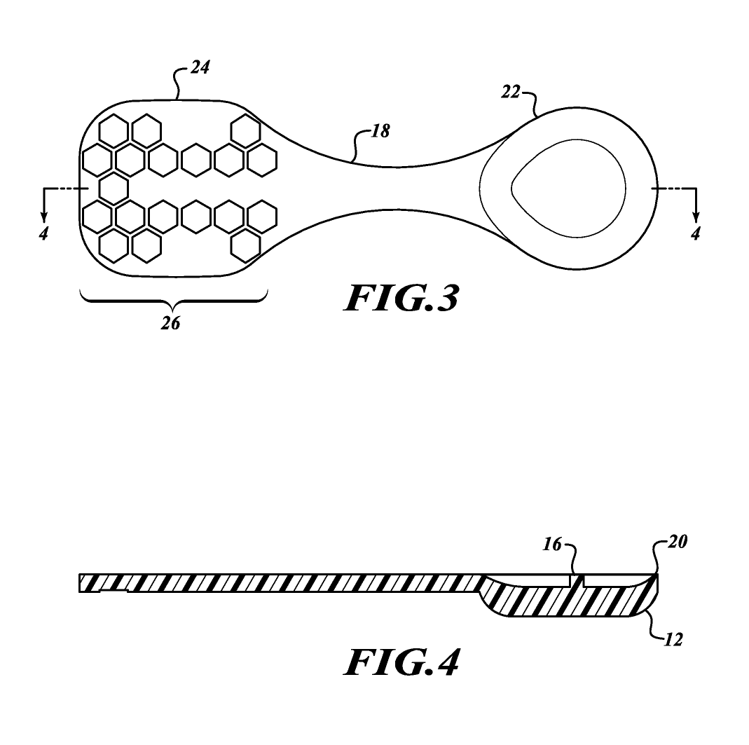

FIG. 3 shows a bottom view of the embodiment of the previous figures. One can see that the handle 18 is affixed to the container 14 at its proximate end 22 and flared at its distal end 24. Because in this embodiment; the condiment dispenser 10 is small, the distal end 24 of the handle is flared to make it easier for a user to hold it in two fingers. In larger embodiments, the handle may be rounded, as in the shape of a dowel, and may even have a non-slip gripping material—such as rubber or neoprene—applied to it. For convenience, the distal end of the handle also may define a hole for hanging the utensil on a hook, or the like, or a hook for hanging the utensil.

Also in FIG. 3, one can see that a convex honeycomb-type design 26 is applied to the flared end of the handle. Such convex design is offered for users to dip and spread honey, hot sauce, dressing, or the like. The entire condiment dispenser 10 is preferably made of unibody construction from washable, durable, food-grade plastic, but any other appropriate material could be chosen, such as wood, metal, or ceramic.

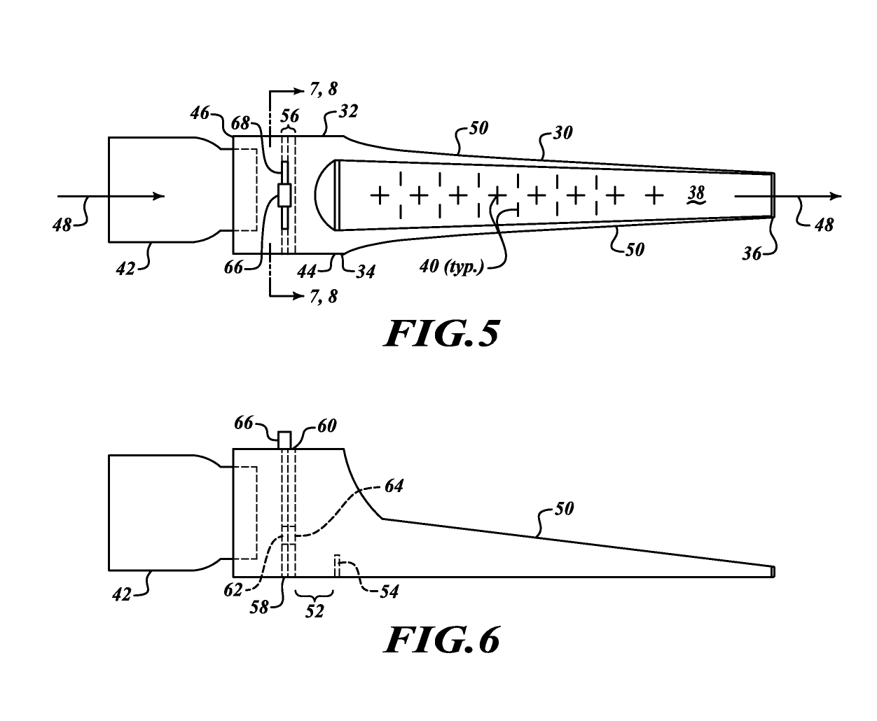

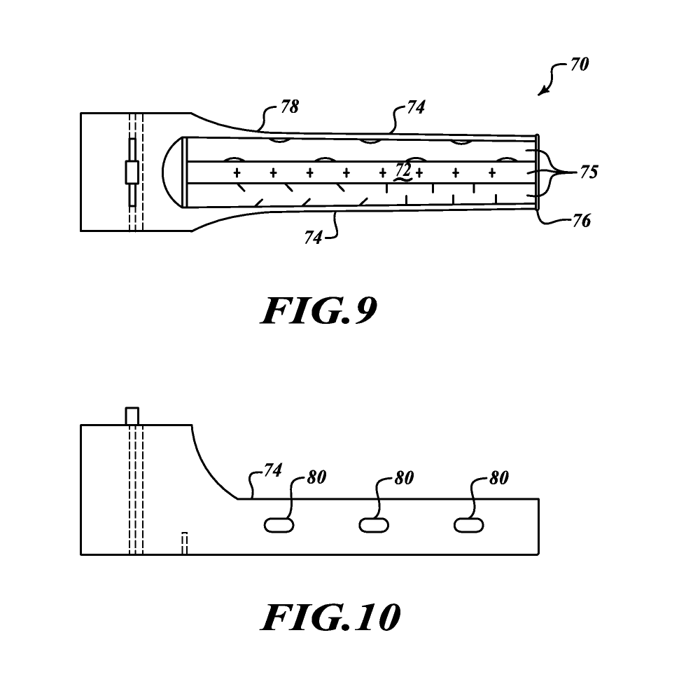

FIG. 5 shows an alternate embodiment of the condiment dispenser having an elongated open box-like container 30 and a handle 32. The container and the handle can be made integrally as one unit or can be made to snap or otherwise attach to each other. The container has a first end 34 (attached to the proximate end 44 of the handle), a second end 36, and a bottom 38 with raised ribs 40. There may or may not be an end wall at the second end 36. This embodiment shows that the handle 32 can be adapted to receive a jar 42 or other condiment receptacle to supply the condiment (not shown). In this embodiment, the jar is screwed into the receptacle at the distal end 42 of the handle such that it is generally in axial alignment with the elongated container 30. Also in this embodiment shown, the ribs are in the form of small crosses and short lines that are positioned generally perpendicular and/or generally parallel to the longitudinal axis 48. (As can be seen in FIGS. 2A, 2B, 2C, and 9, the raised ribs could take several different configurations, such as curved or angled lines, segments, or sections, and can be located adjacent the side walls if desired, and can even be in the form of bumps. The raised ribs can take any appropriate shape as long as they offer some resistance to the centripetal and centrifugal forces acting on the condiment to prevent the condiment from exiting the container in an uncontrolled manner.)

Looking at FIGS. 5 and 6 together, it can be seen that the bottom 38 is a generally flat rectangle with side walls 50 extending therefrom. In this particular embodiment, both the side walls 50 and the bottom 38 taper toward the second end 36 of the container 30. In operation, the condiment grains will travel along the bottom of the container from the first end to the second end, through the “maze” of raised ribs and bumps, and will exit the container usually at the second end where the side walls 50 are lowest. Once again, there may or may not be an end wall at the second end 36. If there is no end wall, then obviously, it will be easier for the condiment grains to exit.

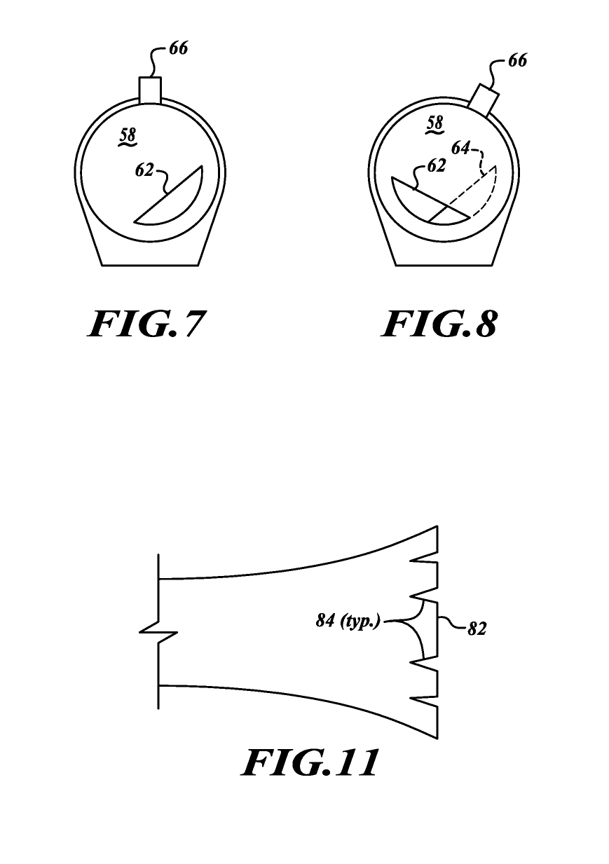

An optional feature of the handle, which makes it more versatile, is the measurement well 52, which is provided so that a user can enhance control over the amount of condiment being distributed. The measurement well 52 is defined by the stop wall 54 and the cooperative gate 56, and can be designed to measure any desired amount of condiment, e.g., a tablespoon, a half-cup, etc. Working with the measurement well in controlling the flow of condiment from the jar 42 is the cooperative gate 56 which comprises two generally circular discs captured within the handle 32, one fixed disc 60 and one rotatable disc 58 adjacent thereto. Both discs have openings —62 and 64—through which condiment from the jar 42 can pass into the measurement well 52 and be introduced into the container. A thumb tab, such as the one shown here at 66, controls the rotation of rotatable disc 58, and FIGS. 7 and 8 show how the thumb tab may be moved to rotate the discs relative to each other to move the gate from a fully open position to a partially closed (intermediate) position. With proper placement and design of the thumb tab 66 in relation to the openings, the gate may be moved from a fully open position to a completely closed position or anywhere in between. In using the cooperative gate in conjunction with the measurement well, a user can exercise further control over the flow of condiment from the jar 42 and the resulting distribution. The thumb tab 66 may be designed to extend out through slot 68 to be on the outside of the handle 32. By manipulating the thumb tab to open the cooperative gate, the user can fill the measurement well with the desired amount of condiment. By then manipulating the thumb tab to close the cooperative gate, the user can ensure that only the predetermined and measured amount of condiment will be distributed. The user can then wave the condiment dispenser in a generally circular or side-to-side motion instead of shaking the dispenser up and down as with regular salt shakers—which method ends up with clumping and/or other poor distribution results. By waving the condiment dispenser in a generally circular or side-to-side flinging motion, the user takes advantage of the centrifugal and centripetal forces generated, instead of simply using gravity as does the typical salt shaker.

FIGS. 9 and 10 show an alternate embodiment 70 similar to the previous embodiment except that the bottom 74 and the side walls 76 do not taper toward the second end 76. In this embodiment, because condiment cannot exit over low walls at the second end 76, there are exit holes 80 defined in the side walls 74. Obviously, the exit holes may vary in size, shape, and number compared to what is shown here, depending on the particular condiment used and the precision of distribution desired. This embodiment shows that the raised ribs may take other shapes and configurations to create a “maze” and put up resistance to the centrifugal and centripetal forces. There may also be generally longitudinal ribs to form channels 75 for the condiment to travel along the bottom. These channels 75 can further separate and help to prevent clumping of the grains—even within the container.

FIG. 11 shows yet another embodiment wherein the bottom of the container flares toward the second end. In this embodiment, the edge 82 of the bottom (at the second end of the container) may define a plurality of notched openings 84 to further allow egress of condiment.

What is claimed is:

1. A condiment dispenser comprising: a container with raised ribs therein for hindering centripetal and centrifugal forces, and a handle affixed to said container.

2. The condiment dispenser of claim 1 wherein said container is in the form of a shallow bowl and said ribs form a cross.

3. The condiment dispenser of claim 1 wherein said handle is affixed to said container at a proximate end and is flared at a distal end.

4. The condiment dispenser of claim 1 wherein said ribs generally form a star shape.

5. The condiment dispenser of claim 1 wherein said ribs generally form a pinwheel shape.

6. The condiment dispenser of claim 1 wherein said container is in the form of a shallow bowl having an outer perimeter edge and an inner bowl.

7. A condiment dispenser comprising: an elongated container having a first end and a second end and also having a bottom with raised ribs extending from said bottom for hindering centripetal and centrifugal forces generated upon waving, and a handle having a distal end and a proximate end, said proximate end being affixed to said first end of said container.

8. The condiment dispenser of claim 7 wherein said bottom is generally a flat rectangle and said container also comprises generally longitudinal side walls extending from said bottom.

9. The condiment dispenser of claim 8 wherein said generally rectangular bottom and said generally longitudinal side walls taper toward said second end of said container.

10. The condiment dispenser of claim 8 wherein said generally longitudinal side walls define side holes.

11. The condiment dispenser of claim 8 wherein said generally rectangular bottom flares toward said second end of said container, and said bottom further defines a plurality of notched openings for the controlled exit of condiment.

12. The condiment dispenser of claim 8 wherein said handle is adapted to receive a threaded jar at said distal end, said jar to be generally in axial alignment with said elongated container.

13. The condiment dispenser of claim 12 wherein said handle further comprises a cooperative gate for allowing communication between said jar and said container.

14. The condiment dispenser of claim 13 wherein said cooperative gate comprises two generally circular discs defining openings therein operable in a range between a fully open position and a completely closed position.

15. The condiment dispenser of claim 14 wherein said cooperative gate is activated with a thumb control located on the outside of said handle.

16. A method of using a condiment dispenser designed to control the distribution of condiment by taking advantage of centrifugal and centripetal forces, wherein said condiment dispenser comprises a container with raised ribs therein and a handle affixed thereto, said method comprising the steps of: selecting a granular condiment to be distributed; gripping said condiment dispenser by said handle; filling said container of said condiment dispenser with said condiment; and waving said dispenser over a chosen distribution area so that the condiment is distributed thereon.

17. The method of claim 16 wherein the condiment is chosen from the group comprising salt-type and sugar-type condiments.

18. The method of claim 16 wherein said container is filled with condiment from a condiment jar received into said handle of said condiment dispenser, wherein said jar communicates with said container.

19. The method of claim 18 wherein said handle further comprises a measurement well and a stop wall to measure a predetermined measurement of condiment from said jar to be introduced into said container for distribution.

20. The method of claim 16 wherein said condiment dispenser is waved in a generally circular pattern over the desired distribution area and said raised ribs control the exit of said condiment grains from said container by hindering the centrifugal and centripetal forces generated thereby, such that said condiment will be evenly and predictably distributed throughout said chosen distribution area.
